(19) United States
(12) Patent Application Publication
(10) Pub. No.: US 2026/0312333 A1
(43) Pub. Date: Oct. 8, 2026

(54) CONNECTOR THAT RETAINS RESPECTIVE END PORTIONS OF PLURALITY OF WIRES

(71) Applicant: KYOCERA Document Solutions Inc., Osaka (JP)

(72) Inventor: Minoru SHINBA, Osaka (JP)

(73) Assignee: KYOCERA Document Solutions Inc., Osaka (JP)

(21) Appl. No.: 19/638,629

(22) Filed: Apr. 3, 2026

(30) Foreign Application Priority Data
Apr. 8, 2025 (JP) 2025-063908

(51) Int. Cl. H01R 13/58

(52) U.S. Cl. CPC H01R 13/58

(57) ABSTRACT

A connector includes a plurality of wires separated into each single wire, and a connector main body that retains the end portions of the respective wires aligned in a row, so that the end portions of the wires are respectively connected to terminal pins via conductive contacts in the connector main body. The end portions of the wires on the connector main body are divided into two groups, along the direction of the longest array of the end portions of the wires. Accordingly, the wires are divided into two wire groups, and the wires in the wire group are bundled by a first cable tie, in each of the two wire groups.

### INCORPORATION BY REFERENCE

This application claims priority to Japanese Patent Application No.2025-063908 filed on Apr. 8, 2025, the entire contents of which are incorporated by reference herein.

### BACKGROUND

The present disclosure relates to a connector that retains respective end portions of a plurality of wires.

Existing electrical connectors generally include an array of a plurality of wire reception recesses, each of which receives and retains a wire, and an array of a plurality of insertion holes each of which receives and retains a post terminal (terminal pin). One each of the wire reception recess and the insertion hole are located adjacent to each other to constitute a pair, and a contact crossing the wire reception recess and the insertion hole is provided in each pair, so that the wire in the wire reception recess and the post terminal in the insertion hole are connected via the contact.

Further, in existing connector units, a circuit board-side FFC connection port is provided on one side of an FFC pitch conversion connector, and a harness port (device-side connection port), aligned in three stages in the up-down direction, is provided on the other side of the FFC pitch conversion connector. To the FFC connection port of the FFC pitch conversion connector, the FFC (circuit board-side cable) connected to the circuit board is removably attached. In addition, to the harness port of three stages, three pin connectors, each connected to a harness of loose wires (device-side cable), are respectively inserted. The three sets of harness of loose wires are each connected to the circuit board, via the corresponding pin connector, the FFC pitch conversion connector, and the FFC.

### SUMMARY

The disclosure proposes further improvement of the foregoing techniques.

In an aspect, the disclosure provides a connector including a plurality of wires, and a connector main body. The plurality of wires are separated into each single wire. The connector main body includes a plurality of joints, to each of which an end portion of the wire is to be connected, the joints being aligned in one direction. In the connector, the end portion of the wire connected to the joint is connected to one of terminal pins, via one of conductors in the connector main body. The wires aligned in the one direction, to be connected to the respective joints of the connector main body, are divided into a plurality of wire groups in the one direction, and the wires included in the wire group are bundled by a first cable tie, in each of the wire groups.

### BRIEF DESCRIPTION OF THE DRAWINGS

FIG. 1 is a plan view showing a two-row connector according to an embodiment of the disclosure;

FIG. 2A and FIG. 2B are a plan view and a front view, respectively, schematically showing the two-row connector according to the embodiment;

FIG. 3 is a perspective view showing terminal pins aligned in two rows;

FIG. 4 is a plan view showing the wires of the two-row connector according to the embodiment, divided into two wire groups, each bundled by a first cable tie, the two wire groups being bundled together by a second cable tie;

FIG. 5 is a plan view showing a two-row connector, two first cable ties, a second cable tie, and a ring-shaped ferrite core according to a variation; and

FIG. 6 is a plan view showing a two-row connector and one cable tie according to a comparative example.

### DETAILED DESCRIPTION

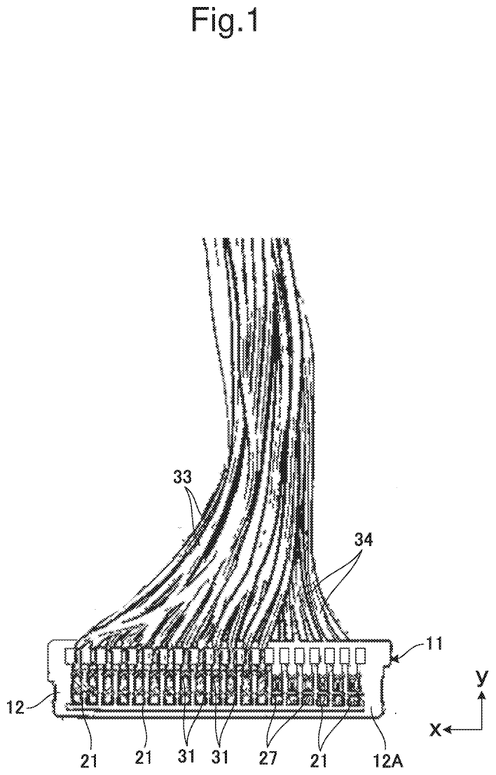

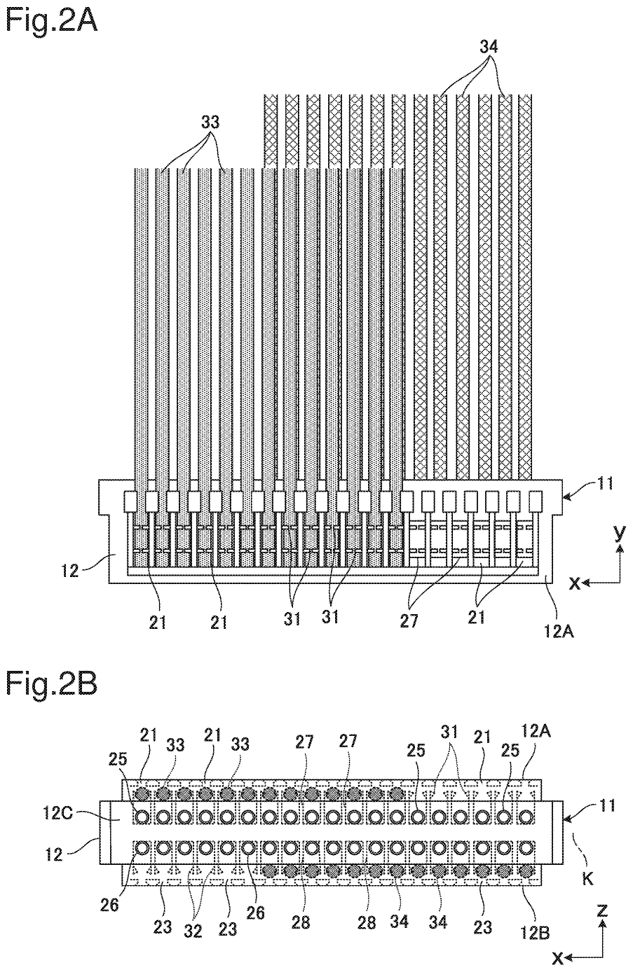

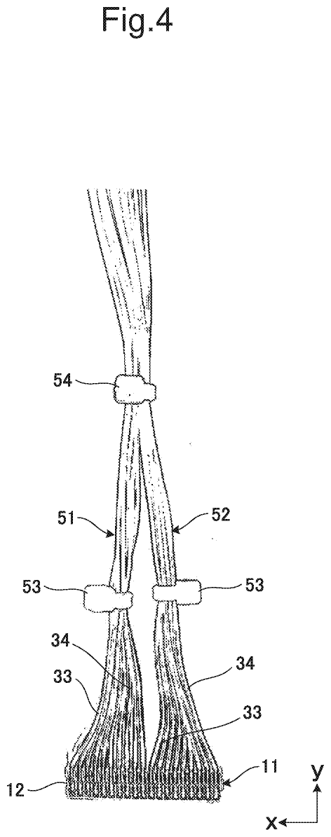

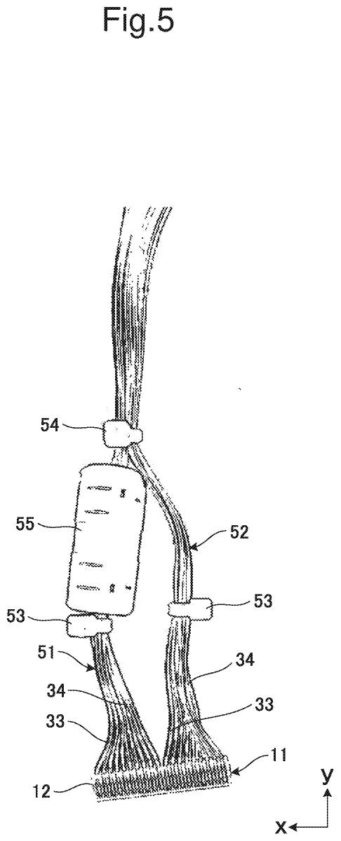

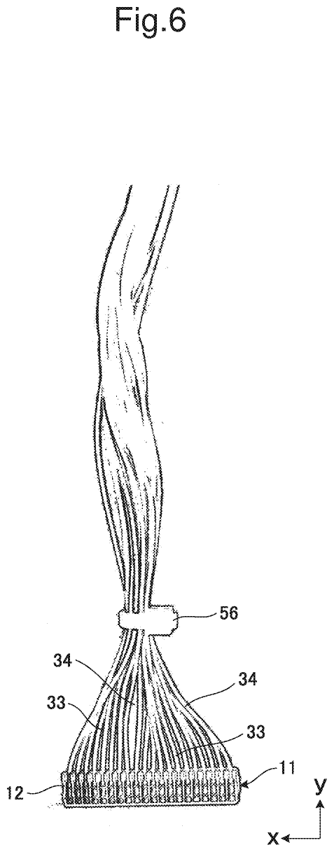

Hereafter, an embodiment of the disclosure will be described, with reference to the drawings. FIG. 1 is a plan view showing a two-row connector according to an embodiment of the disclosure. FIG. 2A and FIG. 2B are a plan view and a front view, respectively, schematically showing the two-row connector according to the embodiment. In FIG. 1, FIG. 2A, and FIG. 2B, and also FIG. 4, FIG. 5, and FIG. 6 to be subsequently referred to, the transverse direction in the two-row connector 11 in FIG. 1, FIG. 2A, FIG. 2B, and FIG. 4 to 6, exemplifying the one direction according to the disclosure, will be denoted by x, the vertical direction in FIG. 1, FIG. 2A, and FIG. 4 to 6 will be denoted by y, and an up-down direction in FIG. 2B will be denoted by z.

As shown in FIG. 1, FIG. 2A, and FIG. 2B, the two-row connector 11 includes a connector main body 12 of a generally rectangular solid shape, formed by molding an insulative synthetic resin, and a plurality of wires 33 and 34, and the end portions of the respective wires 33 and 34 are retained by the connector main body 12. The connector main body 12 includes one face (hereinafter, A-face) 12A and the other face (hereinafter, B-face) 12B, opposed to each other in the up-down direction z. The A-face 12A and the B-face 12B extend in the transverse direction x and the vertical direction y. The connector main body 12 also includes an end face 12C, extending in the transverse direction x and the up-down direction z.

On the A-face 12A of the connector main body 12, a plurality of groove joints 21, each extending in the vertical direction y, are aligned in the transverse direction x. Likewise, on the B-face 12B of the connector main body 12, a plurality of groove joints 23, each extending in the vertical direction y, are aligned in the transverse direction x. The groove joints 21 and the groove joints 23 constitute two rows, parallel to each other and stacked on each other in the up-down direction z. The groove joint 21 and the groove joint 23 correspond to the first joint according to the disclosure.

On the end face 12C of the connector main body 12, a plurality of hole joints 25, each extending in the vertical direction y, are aligned in the transverse direction x, and also a plurality of hole joints 26 each extending in the vertical direction y are aligned in the transverse direction x. The hole joints 25 and the hole joints 26 constitute, like the groove joints 21 and the groove joints 23, two rows parallel to each other, and stacked on each other in the up-down direction z.

The groove joints 21 on the A-face 12A of the connector main body 12 are respectively located adjacent to the hole joints 25 on the end face 12C of the connector main body 12 in the up-down direction z, and one of the groove joints 21 and one of the hole joints 25 adjacent to each other constitute a pair. Likewise, the groove joints 23 on the B-face 12B of the connector main body 12 are respectively located adjacent to the hole joints 26 on the end face 12C of the connector main body 12 in the up-down direction z, and one of the groove joints 23 and one of the hole joints 26 adjacent to each other constitute a pair.

A conductive contact 27, for communication across the groove joint 21 and the hole joint 25, is provided for each of the pairs of the groove joint 21 on the A-face 12A of the connector main body 12 and the hole joint 25 on the end face 12C of the connector main body 12. Likewise, a conductive contact 28, for communication across the groove joint 23 and the hole joint 26, is provided for each of the pairs of the groove joint 23 on the B-face 12B of the connector main body 12 and the hole joint 26 on the end face 12C of the connector main body 12.

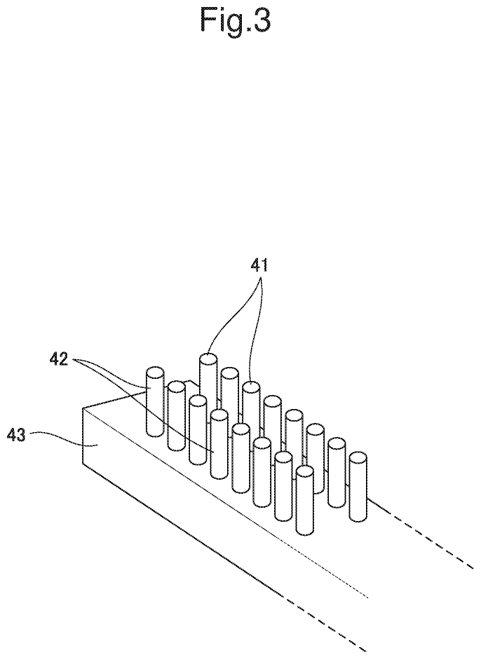

The conductive contact 27 or 28 includes a non-illustrated contact portion, located in contact with a pair of contact projections 31 or 32 protruding toward each other, to the inner region of the groove joint 21 or 23, and with a terminal pin 41 or 42 (see FIG. 3) inserted to the inside of the hole joint 25 or 26.

In each of the groove joints 21 on the A-face 12A of the connector main body 12, an end portion of a wire 33, separated into each single wire, is press-inserted and retained, and the end portions of the respective wires 33 are aligned in the transverse direction x. Likewise, in each of the groove joints 23 on the B-face 12B of the connector main body 12, an end portion of a wire 34, separated into an individual line, is press-inserted and retained, and the end portions of the respective wires 34 are aligned in the transverse direction x. The wires 33 and 34 are formed by coating a conductive core wire with an insulative synthetic resin.

When the end portion of the wire 33 is press-inserted into the groove joint 21 and retained therein, in each of the groove joints 21 on the A-face 12A of the connector main body 12, the coating of the end portion of the wire 33 is torn by being caught between the pair of contact projections 31 of the conductive contact 27, so that the conductive core wire of the wire 33 makes contact with the contact projections 31, thereby establishing the connection with the conductive contact 27. Likewise, when the end portion of the wire 34 is press-inserted into the groove joint 23 and retained therein, the coating of the end portion of the wire 34 is torn by being caught between the pair of contact projections 32 of the conductive contact 28, so that the conductive core wire of the wire 34 makes contact with the contact projections 32, thereby establishing the connection with the conductive contact 28.

Two rows of terminal pins, namely the terminal pins 41 and 42 shown in FIG. 3, are respectively inserted in the two rows of hole joints, namely the hole joints 25 and 26, on the end face 12C of the connector main body 12. The terminal pins 41 and the terminal pins 42 are each formed so as to stick out from a rectangular base plate 43, formed by molding an insulative synthetic resin. The base plate 43 is fixed to a non-illustrated printed circuit board, and the terminal pins 41 and the terminal pins 42 are connected to respective parts, via conductor patterns formed on the printed circuit board.

When the terminal pins 41 aligned in a row are respectively inserted in the hole joints 25 aligned in a row on the end face 12C of the connector main body 12, the terminal pins 41 each make contact with the contact portion of the conductive contact 27, inside the hole joint 25. Since the conductive core wire of the wire 33 is, as described above, in contact with the contact projection 31 of the conductive contact 27 in each of the groove joints 21 on the A-face 12A of the connector main body 12, the terminal pin 41 in each of the hole joints 25 is connected to the conductive core wire of the wire 33 in the groove joint 21, via the conductive contact 27. Likewise, when the terminal pins 42 aligned in a row are respectively inserted in the hole joints 26 aligned in a row on the end face 12C of the connector main body 12, the terminal pins 42 each make contact with the contact portion of the conductive contact 28, inside the hole joint 26. Since the conductive core wire of the wire 34 is, as described above, in contact with the contact projection 32 of the conductive contact 28 in each of the groove joints 23 on the B-face 12B of the connector main body 12, the terminal pin 42 in each of the hole joints 26 is connected to the conductive core wire of the wire 34 in the groove joint 23, via the conductive contact 28.

As described above, when the end portion of the wire 33 is fitted in the groove joint 21 on the A-face 12A of the connector main body 12, so that the conductive core wire of the wire 33 is connected to the conductive contact 27, and the terminal pins 41 aligned in a row are respectively inserted in the hole joints 25 aligned in a row on the end face 12C of the connector main body 12, the terminal pin 41 is connected to the conductive core wire of the wire 33 in the groove joint 21, via the conductive contact 27. Likewise, when the end portion of the wire 34 is fitted in the groove joint 23 on the B-face 12B of the connector main body 12, so that the conductive core wire of the wire 34 is connected to the conductive contact 28, and the terminal pins 42 aligned in a row are respectively inserted in the hole joints 26 aligned in a row on the end face 12C of the connector main body 12, the terminal pin 42 is connected to the conductive core wire of the wire 34 in the groove joint 23, via the conductive contact 28.

As described above, the terminal pins 41 and the terminal pins 42 are respectively connected to the parts, via the conductor patterns on the printed circuit board. Accordingly, the wires 33 and 34 are respectively connected to the conductor patterns on the printed circuit board, via the conductive contacts 27 and 28 on the two-row connector 11 and the terminal pins 41 and 42, and further to the parts via the conductor patterns.

Now, there are cases where the wires 33 and 34, separated into each single wire, are bundled by a cable tie, at a position in the proximity of the connector main body 12. In this case, when a large number of wires 33 and 34 are bundled, the wires 33 and 34 are prone to be subjected to stress, when the connector 11 is to be removed from the printed circuit board (terminal pin 41 and terminal pin 42 of the base plate 43), and the wires may be broken. Presumably, this is because, when the cable tie is located in the proximity of the connector main body 12, the wires 33 and 34 retained by the groove joints 21 located close to the center of the connector main body 12 extend generally linearly, while the wires 33 and 34, retained by the groove joints 21 located close to the end portions of the connector main body 12, are largely bent at the position close thereto, and therefore the wires 33 and 34 are subjected to an uneven load, when the connector 11 is removed.

However, when the cable tie is located far from the connector main body 12, the wires 33 and 34 are unable to be securely bundled, which leads to degraded workability in removing the connector 11.

Further, in the case of the mentioned two-row connector 11, a significantly larger number of wires and terminal pins are involved, and therefore a larger force is required to remove the connector 11 from the terminal pins, which further increases the risk that the wires are broken.

In this embodiment, accordingly, the wires 33 and 34, aligned in the transverse direction x to be respectively connected to the groove joint 21 and the groove joint 23 of the connector main body 12, are divided into a plurality of wire groups 51 and 52 in the transverse direction x, and the wires 33 and 34 included in each of the wire groups 51 and 52 are bundled by a first cable tie 53, as shown in FIG. 4. Further, the wire groups 51 and 52 are bundled together by a second cable tie 54, at a position more distant from the connector main body 12, than are the first cable ties 53. Here, it is preferable that each of the wire groups 51 and 52, each bundled by the first cable tie 53, includes the number of wires that minimizes a difference in tensile force, exerted to each of the wires 33 and 34 bundled by the first cable tie 53, when the two wire groups 51 and 52 bundled by the second cable tie 54 are subjected to a tensile force in the longitudinal direction.

In the case where, as described above, the wires 33 and 34 are divided into the two wire groups 51 and 52 in the transverse direction x, and the wire groups 51 and 52 are each bundled by the first cable tie 53, the width of the array of the end portions of the respective wires 33 and 34 in the transverse direction x becomes narrower in each of the wire groups 51 and 52, and therefore the difference in extent of curvature among the wires 33 and 34, at the position in the proximity of the connector main body 12, is minimized. Accordingly, when the connector 11 is removed by pulling the wire groups 51 and 52, the wires 33 and 34 are exempted from being subjected to an uneven load, thus to be prevented from being broken. In addition, bundling the wire groups 51 and 52 together with the second cable tie 54 enables the wires 33 and 34 to be securely bundled, which leads to improved workability in removing and attaching the connector 11.

### Variation 1

In a variation 1, the color of the wires 33 and 34 of the wire group 51, and the color of the wires 33 and 34 of the wire group 52 are different from each other. Accordingly, the wires 33 and 34 that should be included in the wire group 51, and the wires 33 and 34 that should be included in the wire group 52 can be easily distinguished, and the process of bundling each of the wire groups 51 and 52 with the first cable tie 53 can be quickly performed.

### Variation 2

In a variation 2, as shown in FIG. 5, a ring-shaped ferrite core 55, through which the wire group 51 is passed, is provided between the first cable tie 53 bundling the wires 33 and 34 of the wire group 51, and the second cable tie 54. In other words, the ring-shaped ferrite core 55 is attached to the position between the first cable tie 53 and the second cable tie 54, on the wire group 51 including the wires 33 and 34 bundled by the first cable tie 53.

Since the wires 33 and 34 of the wire group 51 are securely bundled between the first cable tie 53 and the second cable tie 54, the ring-shaped ferrite core 55 can be easily attached, and also the ring-shaped ferrite core 55 can effectively perform the noise reduction, with respect to the wire group 51.

### Comparative Example

In a comparative example shown in FIG. 6, unlike in the foregoing embodiment, the wires 33 and 34 are bundled together by a single cable tie 56, at the position in the proximity of the connector main body 12. In this case, as described above, the wires 33 and 34 retained by the groove joints 21 located close to the center of the connector main body 12 extend generally linearly, while the wires 33 and 34, retained by the groove joints 21 located close to the end portions of the connector main body 12, are largely bent at the position close thereto, and therefore the wires 33 and 34 are subjected to an uneven load, when the connector 11 is removed. As a result, the wires are prone to be broken.

According to the foregoing embodiment, as described above, the end portions of the respective wires 33 and 34 are divided into two groups, along the direction of the longest array of the end portions of the wires 33 and 34, so that the wires 33 and 34 are divided into the two wire groups 51 and 52. Further, the wires 33 and 34 are bundled by the first cable tie 53 in each of the wire groups 51 and 52, to minimize the difference in extent of curvature of the wires 33 and 34, at the position in the proximity of the connector main body 12. Therefore, the wires 33 and 34 can be exempted from being subjected to an uneven load, and can be effectively prevented from being broken, when the connector 11 is removed by pulling the wire groups 51 and 52. Further, bundling the wire groups 51 and 52 together with the second cable tie 54 enables the wires 33 and 34 to be securely bundled, which leads to improved workability in removing and attaching the connector 11.

Here, the foregoing embodiment represents the case where the coating of the wires 33 and 34 is torn by being caught between the two contact projections 31 and 32 of the conductive contacts 27 and 28, so that the conductive core wire of each of the wires 33 and 34 makes contact with the contact projections 31 and 32, thus to be connected to the conductive contact 27 or 28. However, various connectors, each having a different structure for connecting the end portion of the wire to the conductive contact, are currently known, and therefore the disclosure may be applied to such connectors.

Although the end portions of the respective wires 33 and 34 are divided into two wire groups in the transverse direction x, according to the foregoing embodiment, the end portions of the wires 33 and 34 may be divided into three or more groups, so that the wires 33 and 34 are divided into three or more groups according to the division of the end portions, and the wires of each of those wire groups may be bundled by the first cable tie.

Further, although the two-row connector is taken up as the subject in the foregoing embodiment, the plurality of groove joints to each of which the wire is connected may be aligned in the transverse direction, and such array may be stacked in three or more stages in the up-down direction. Alternatively, the connector may include only one array. The disclosure is applicable to either of such cases.

Now, in the case where the wires fall apart from each other, at a position in the proximity of the joints of the connector, to which the wires are to be connected, the workability in attaching and removing the connector is impaired. Accordingly, the wires are often bundled by a cable tie, at the position in the proximity of the joints of the connector (approximately 30 to 60 mm from the connector). However, in the case of the connector to which a large number of wires are connected, when the wires are bundled at the position in the proximity of the joints of the connector, the wires are prone to be subjected to stress, when the connector is removed from the circuit board, and resultantly the wires may be broken. On the other hand, the configuration according to the foregoing embodiment effectively prevents the wires from being broken, when the connector is removed.

Further, the configurations and processings described in the embodiment with reference to FIG. 1 to FIG. 6 are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims. What is claimed is;

1. A connector comprising:
a plurality of wires separated into each single wire; and
a connector main body including a plurality of joints, to each of which an end portion of the wire is to be connected, the joints being aligned in one direction,
wherein the end portion of the wire connected to the joint is connected to one of terminal pins, via one of conductors in the connector main body, and
the wires aligned in the one direction, to be connected to the respective joints of the connector main body, are divided into a plurality of wire groups in the one direction, and the wires included in the wire group are bundled by a first cable tie, in each of the wire groups.

2. The connector according to claim 1, wherein the wire groups are different in color from each other.

3. The connector according to claim 1, further comprising a second cable tie, bundling the wire groups together at a position more distant from the connector main body, than are the first cable ties bundling the wires of the respective wire groups.

4. The connector according to claim 3, further comprising a ring-shaped ferrite core, attached to a position between the first cable tie and the second cable tie, on the wire group including the wires bundled by the first cable tie.

5. The connector according to claim 3,
wherein the wire groups are each formed by bundling, with the first cable tie, a number of wires that minimizes a difference in tensile force, exerted to each of the wire groups bundled by the first cable tie, when the wire groups bundled by the second cable tie are subjected to a tensile force in a longitudinal direction of the wire groups.
